(19) United States
(12) Patent Application Publication
(10) Pub. No.: US 2018/0075817 A1
(43) Pub. Date: Mar. 15, 2018

(54) DISPLAY DRIVER INTEGRATED CIRCUIT FOR DRIVING DISPLAY PANEL

(71) Applicant: Samsung Electronics Co., Ltd., Suwon-si (KR)

(72) Inventors: Jee-hwal Kim, Seoul (KR); Ki-ho Kong, Suwon-si (KR)

(21) Appl. No.: 15/685,468

(22) Filed: Aug. 24, 2017

(30) Foreign Application Priority Data
Sep. 9, 2016 (KR) 10-2016-0116581
Mar. 3, 2017 (KR) 10-2017-0027774

(51) Int. Cl. G09G 3/36

(52) U.S. Cl. CPC G09G 3/3688; G09G 2310/0297; G09G 2310/027

(57) ABSTRACT

A display driver integrated circuit (DDI) for driving a display panel is provided. The DDI is implemented as a single semiconductor chip including a driver circuit and a switching circuit. The driver circuit outputs image signals to be displayed on pixel groups connected to one gate line of a display panel to a plurality of channels during one horizontal time period. The switching circuit selectively connects each of the plurality of channels to data lines of a corresponding pixel group according to a selection signal indicating a display order of the pixel groups and provides the image signals to selected data lines.

### CROSS-REFERENCE TO RELATED APPLICATIONS

This application claims the benefits of Korean Patent Application No. 10-2016-0116581, filed on Sep. 9, 2016, and Korean Patent Application No. 10-2017-0027774, filed on Mar. 3, 2017, in the Korean Intellectual Property Office, the disclosures of which are incorporated herein in their entireties by reference.

### BACKGROUND

The inventive concept relates to a semiconductor device, and more particularly, to a display driver integrated circuit (DDI) for driving data lines of a display panel and a display device including the DDI.

Display devices include a display panel for displaying images and a DDI for driving the display panel. The display devices operate with low power for applications of electronic devices requiring low power consumption.

### SUMMARY

The inventive concept provides a display driver integrated circuit (DDI) capable of operating with low power.

The inventive concept also provides a display device including a DDI capable of operating with low power.

According to an aspect of some embodiments, there is provided a display driver integrated circuit implemented as a single semiconductor chip, the display driver integrated circuit including a driver circuit configured to output image signals to be displayed on pixel groups connected to one gate line of a display panel to a plurality of channels during one horizontal time period, and a switching circuit configured to selectively connect each of the plurality of channels to data lines of a corresponding pixel group and provide the image signals to selected data lines, according to a selection signal indicating a display order of the pixel groups.

According to some embodiments, there is provided a display device including a display panel including a plurality of pixels, a timing controller configured to determine a driving order of pixel groups, which are time-divisionally driven for one horizontal time based on image data to be displayed on the display panel, and to generate a selection signal according to the driving order, and a display driver integrated circuit of a single semiconductor chip configured to convert the image data into image signals and provide the image signals to data lines of the display panel, according to the selection signal. The display driver integrated circuit includes a driver circuit configured to output the image signals to a plurality of channels, and a switching circuit configured to selectively connect each of the plurality of channels to data lines of a corresponding pixel group according to the selection signal.

According to some embodiments, a semiconductor chip includes a display driver integrated circuit. The display driver integrated circuit includes a plurality of driver circuits that are configured to output image signals to a display panel external to the display driver, the output image signals, responsive to respective data selection signals that are based on one or more of a plurality of group selection signals. Activation of ones of the plurality of group selections signals control output of the image signals to associated respective groups of pixels of the display panel. Activation of ones of the plurality of group selection signals are mutually exclusive of activation of others of the plurality of the group selection signals during a horizontal time period.

It is noted that aspects of the inventive concepts described with respect to one embodiment, may be incorporated in a different embodiment although not specifically described relative thereto. That is, all embodiments and/or features of any embodiment can be combined in any way and/or combination. These and other aspects of the inventive concepts are described in detail in the specification set forth below.

### BRIEF DESCRIPTION OF THE DRAWINGS

Embodiments of the inventive concept will be more clearly understood from the following detailed description taken in conjunction with the accompanying drawings in which:

FIG. 1 is a block diagram of a display device according to an embodiment of the inventive concept;

FIG. 2 is a diagram illustrating parts of the display panel and the display driver integrated circuit (DDI) of FIG. 1;

FIG. 3 is a timing diagram illustrating driving waveforms of the display device of FIG. 2;

FIG. 4 is a diagram illustrating an example switching circuit disposed in a part of a display panel, as a comparative example of FIG. 2;

FIG. 5 is a diagram illustrating a display device according to embodiments of the inventive concept;

FIG. 6 is a diagram illustrating a display device according to embodiments of the inventive concept;

FIG. 7 is a timing diagram illustrating driving waveforms of the display device of FIG. 6;

FIG. 8 is a view illustrating a display module including a display device according to embodiments of the inventive concept;

FIG. 9 is a view illustrating a touch screen module to which a display device according to embodiments of the inventive concept is applied; and

FIG. 10 is a block diagram illustrating an example display device according to embodiments of the inventive concept as applied to a mobile device.

### DETAILED DESCRIPTION OF THE EMBODIMENTS

Hereinafter, embodiments of the inventive concept will be described in detail with reference to the accompanying drawings.

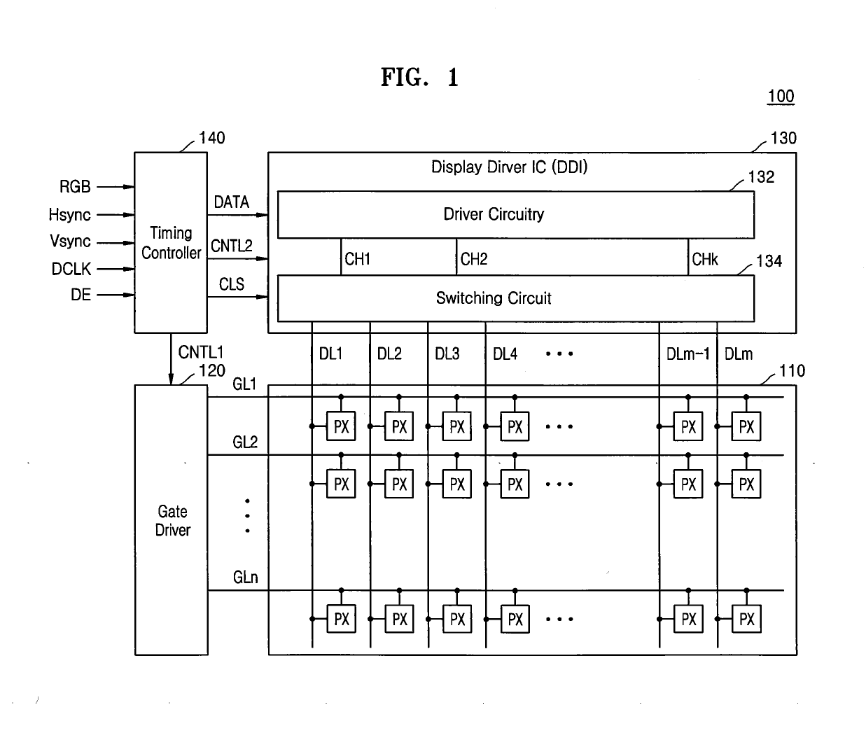

FIG. 1 is a block diagram of a display device 100 according to embodiments of the inventive concept.

Referring to FIG. 1, the display device 100 may include a display panel 110, a display driver integrated circuit 130 (hereinafter, referred to as ‘DDI’), a gate driver 120, and a timing controller 140.

The display device 100 may be an electronic device having an image display function. For example, the electronic device may include at least one selected from a smartphone, a tablet personal computer, a mobile phone, a videophone, an e-book reader, a desktop personal computer (PC), a laptop PC, a netbook computer, a personal digital assistant (PDA), a portable multimedia player (PMP), an MP3 player, a mobile medical device, a camera, and/or a wearable device (e.g., a head-mounted-device (HMD) such as electronic glasses, an electronic garment, an electronic bracelet, an electronic necklace, an electronic appcessory, an electronic tattoo, and/or a smart watch).

According to some embodiments, the display device 100 may be a smart home appliance with an image display function. For example, the smart home appliance may include at least one selected from a television, a digital video disk (DVD) player, an audio set, a refrigerator, an air conditioner, a vacuum cleaner, an oven, a microwave oven, a washing machine, an air purifier, a set-top box, a TV box (e.g., Samsung HomeSync®, Apple TV®, or Google TV®), a game console, an electronic dictionary, an electronic key, a camcorder, or an electronic frame.

According to some embodiments, the display device 100 may include at least one selected from a medical device (e.g., magnetic resonance angiography (MRA), magnetic resonance imaging (MRI), computed tomography (CT), a moving-camera, or an ultrasound device), a navigation device, a global positioning system (GPS) receiver, an event data recorder (EDR), a flight data recorder (FDR), an automotive infotainment device, a marine electronic device (e.g., a marine navigation device or a gyro compass), avionics, a security device, a car head unit, an industrial or home robot, an automatic teller's machine (ATM), or a point of sale (POS) device.

According to some embodiments, the display device 100 may include at least one selected from a piece of furniture having an image display function, a part of a building/structure having an image display function, an electronic board, an electronic signature receiving device, a projector, or a measuring instrument (e.g., a water, electricity, gas, or radio wave measuring instrument).

An electronic device including the display device 100 according to embodiments of the inventive concept may be one or more of the various devices described above. In addition, the display device 100 may be a flexible device. The display device 100 according to embodiments of the inventive concept is not limited to the above-described devices.

The display panel 110 includes a plurality of pixels PX arranged in a matrix form. The display panel 110 may display an image by units of frames. The display panel 110 may be implemented with one selected from a liquid crystal display (LCD), a light-emitting diode (LED) display, an organic LED (OLED) display, an active-matrix OLED (AMOLED) display, an electrochromic display (ECD), a digital micromirror device (DMD), an actuated mirror device (AMD), a grating light value (GLV), a plasma display panel (PDP), an electro luminescent display (ELD), or a vacuum fluorescent display (VFD), or may be implemented with a flat panel display or a flexible display. Although any type of display panel may be used, for convenience of description, an OLED panel will be described as an example of the display panel 110.

The display panel 110 includes gate lines GL1 to GLn arranged in the row direction, data lines DL1 to DLm arranged in the column direction, and pixels PX formed at intersections of the gate lines GL1 to GLn and the data lines DL1 to DLm. The display panel 110 includes a plurality of horizontal lines, and one horizontal line may include pixels PX connected to one gate line. During one horizontal time period (1H time period), pixels PX of one horizontal line may be driven and during the next 1H time period, pixels PX of another horizontal line may be driven.

Each of the pixels PX may include an LED and a diode-driving circuit that independently drives the LED. The diode-driving circuit may be connected to one gate line and/or one data line, and the LED may be connected between the diode-driving circuit and a power source voltage (e.g., a ground voltage).

The diode-driving circuit may include a switching element, for example, a thin film transistor (TFT), connected to a corresponding gate line of the gate lines GL1 to GLn. When a gate-on signal is applied to the corresponding gate line of the gate lines GL1 to GLn such that the switching element TFT is turned on, the diode-driving circuit may supply an image signal (or a pixel signal) received from a corresponding data line of the data lines DL1 to DLm connected to the diode-driving circuit to the LED. The LED may output an optical signal corresponding to the image signal.

In the display panel 110, pixels PX (hereinafter, referred to as a red pixel, a green pixel, and a blue pixel) for outputting red (R) light, green (G) light, and blue (B) light, respectively may be repeatedly arranged.

According to some embodiments, the pixels PX of the display panel 110 may be repeatedly arranged in the order of R, G, B, and G, or in the order of B, G, R, and G. This arrangement structure of the pixels PX may be referred to as a pentile structure. The display panel 110 having the pentile structure may include odd horizontal lines in which pixels PX are arranged in the order of R, G, B, and G, and even horizontal lines in which pixels PX are arranged in the order of B, G, R, and G. A pentile structure includes two subpixels per pixel, with twice as many green pixels than red and blue pixels.

According to some embodiments, the pixels PX of the display panel 110 may be repeatedly arranged in the order of R, G, and B, or in the order of B, G, and R. This arrangement structure of the pixels PX may be referred to as an RGB stripe structure.

The gate driver 120 may sequentially provide a gate-on signal to the gate lines GL1 to GLn in response to a gate control signal CNTL1. For example, the gate control signal CNTL1 may include a gate start pulse for instructing the start of the output of the gate-on signal and a gate shift clock for controlling the output time of the gate-on signal.

When the gate start pulse is applied to the gate driver 120, the gate driver 120 may sequentially generate a gate-on signal (e.g., a gate voltage having a logic high level) in response to the gate shift clock and sequentially provide the gate-on signal to the gate lines GL1 to GLn. In this case, a gate-off signal (e.g., a gate voltage having a logic low level) is supplied to the gate lines GL1 to GLn during a period in which the gate-on signal is not provided to the gate lines GL1 to GLn.

The DDI 130 may convert digital image data DATA into analog image signals and provide the analog image signals to the data lines DL1 to DLm, in response to a data control signal CNTL2 and a selection signal CLS. The DDI 130 may provide an image signal for one horizontal line to the data lines DL1 to DLm for time period 1H.

The DDI 130 may be implemented as a single semiconductor integrated circuit (IC) chip including a driver circuit 132 and a switching circuit 134. The driver circuit 132 may convert the digital image data DATA into image signals in response to a data control signal CNTL2. The driver circuit 132 may output image signals at a gray-scale voltage corresponding to the image data DATA and may provide the image signals to a plurality of channels CH1 to CHk. For example, the data control signal CNTL2 may include a source start pulse (SSP) signal, a source shift clock (SSC) signal, and a source output enable (SOE) signal.

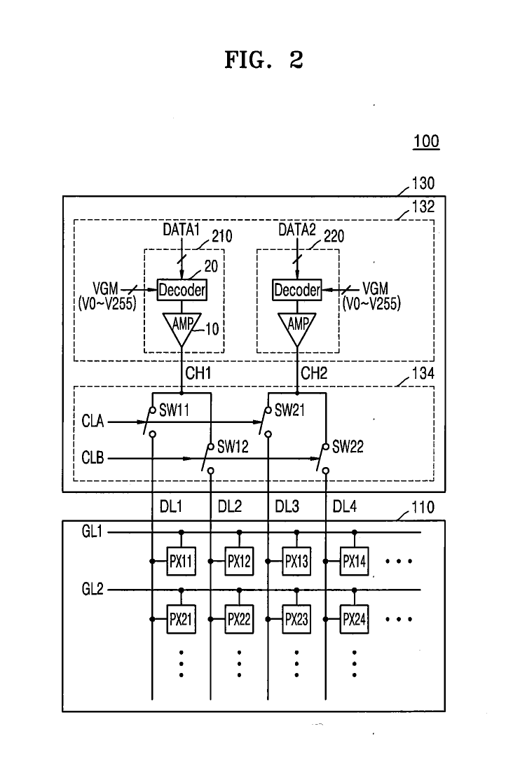

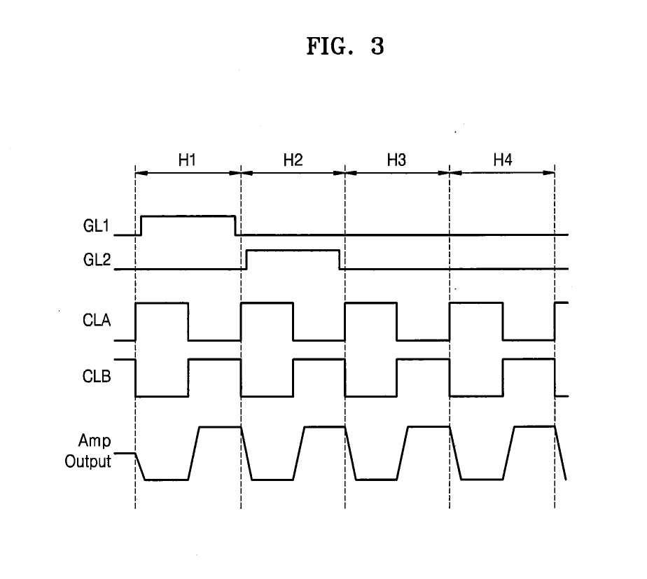

The switching circuit 134 may connect each of the plurality of channels CH1 to CHk to two data lines DL1 to DLm in response to the selection signal CLS. For example, the selection signal CLS may include a first selection signal CLA and a second selection signal CLB (see FIGS. 2 and 3).

For example, the switching circuit 134 may connect each of the channels CH1 to CHk to odd-numbered data lines DL1, DL3, . . . , and DLm−1 in response to the first selection signal CLA and connect each of the channels CH1 to CHk to even-numbered data lines DL2, DL4, . . . , and DLm in response to the second selection signal CLB. Accordingly, in the display panel 110, pixels connected to the odd-numbered data lines DL1, DL3, . . . , and DLm−1 may be selected to display an image signal of a channel corresponding thereto among channels CH1 to CHk and pixels connected to the even-numbered data lines DL2, DL4, . . . , and DLm may be selected to display an image signal of a channel corresponding thereto among channels CH1 to CHk.

According to some embodiments, the switching circuit 134 may connect each of the plurality of channels CH1 to CHk to data lines DL1 to DLm in response to the first and second selection signals CLA and CLB and a third selection signal CLC.

The timing controller 140 may receive video image data RGB from the outside and may process the video image data RGB or convert the video image data RGB so as to be suitable for the structure of the display panel 110 to generate the image data DATA. The timing controller 140 may transmit the image data DATA to the DDI 130.

The timing controller 140 may receive a plurality of control signals from an external host device. The control signals may include a horizontal synchronization signal Hsync, a vertical synchronization signal Vsync, a clock signal DCLK, and a data enable signal DE.

The timing controller 140 may generate the gate control signal CNTL1, the data control signal CNTL2, and the selection signal CLS for controlling the gate driver 120 and the DDI 130, based on the received control signals. The timing controller 140 may control various operation timings of the gate driver 120 and the DDI 130 according to the gate control signal CNTL1, the data control signal CNTL2, and the selection signal CLS.

The timing controller 140 may control the gate driver 120 to drive the gate lines GL1 to GLn by the gate control signal CNTL1. The timing controller 140 may control the DDI 130 to display an image signal on the data lines DL1 to DLm of the display panel 110 by the data control signal CNTL2.

FIG. 2 is a diagram illustrating parts of the display panel 110 and the DDI 130 of FIG. 1.

Referring to FIG. 2, first to fourth data lines DL1 to DL4 of the plurality of data lines DL1 to DLm are shown in the display panel 110. A plurality of pixels PX11 to PX14 and PX21 to PX24 are connected to the first to fourth data lines DL1 to DL4. The pixels PX11 to PX14 of a first horizontal line are connected to a first gate line GL1, and the pixels PX21 to PX24 of a second horizontal line are connected to a second gate line GL2. The first and second gate lines GL1 and GL2 may be driven by the gate driver 120 (see FIG. 1).

The DDI 130 includes a driver circuit 132 and a switching circuit 134. The driver circuit 132 includes a plurality of drivers 210 and 220 and the switching circuit 134 includes a plurality of switches SW11, SW12, SW21, and SW22.

In the current embodiment, an operation in which the DDI 130 drives the first to fourth data lines DL1 to DL4 of the display panel 110 will be described in detail. Accordingly, the driver circuit 132 includes two drivers 210 and 220, and the switching circuit 134 includes four switches SW11, SW12, SW21, and SW22. According to some embodiments, the number of drivers 210 and 220 and the number of switches SW11, SW12, SW21, and SW22 may vary depending on the resolution of the display panel 110 and/or the number of data lines.

Each of the drivers 210 and 220 may include a channel amplifier 10 and a decoder 20. The drivers 210 and 220 (hereinafter, referred to as “first and second drivers 210 and 220”) may convert first and second image data DATA1 and DATA2 received from the timing controller 140 into image signals and output the image signals to the channels CH1 and CH2, respectively.

The decoder 20 of the first driver 210 may receive a plurality of gamma voltages VGM and the first image data DATA1. The decoder 20 may select and output a gamma voltage corresponding to the first image data DATA1 among the plurality of gamma voltages VGM. The plurality of gamma voltages VGM may include, for example, first to 256th gamma voltages V0 to V256.

The gradation of the pixels PX in the display panel 110 may not change linearly according to the voltage level of an image signal but may change nonlinearly. A plurality of gamma voltages VGM reflecting gamma characteristics may be provided to the decoder 20 to prevent deterioration of image quality due to the gamma characteristics. The decoder 20 selects a gamma voltage corresponding to the first image data DATA1 and provides the selected gamma voltage to the channel amplifier 10.

The channel amplifier 10 of the first driver 210 may output the gamma voltage corresponding to the first image data DATA1, received from the decoder 20, as an image signal to the first channel CH1. The first channel CH1 may be selectively connected to the first and second data lines DL1 and DL2 through the first and second switches SW11 and SW12 of the switching circuit 134.

The second driver 220 may receive the second image data DATA2, and select a gamma voltage corresponding to the second image data DATA2 among the plurality of gamma voltages VGM, and output the selected gamma voltage as an image signal to the second channel CH2. The second channel CH2 may be selectively connected to the third and fourth data lines DL3 and DL4 through the third and fourth switches SW21 and SW22 of the switching circuit 134.

The first and second switches SW11 and SW12 of the switching circuit 134 may be connected between the first channel CH1 and the first and second data lines DL1 and DL2, respectively. The third and fourth switches SW21 and SW22 of the switching circuit 134 may be connected between the second channel CH2 and the third and fourth data lines DL3 and DL4, respectively. The first to fourth switches SW11, SW12, SW21, and SW22 may be implemented in the DDI 130 by using a metal oxide semiconductor field effect transistor (MOSFET) manufacturing process.

The first switch SW11 is turned on in response to the first selection signal CLA and the second switch SW2 is turned on in response to the second selection signal CLB. The first and second switches SW11 and SW12 connected to the first channel CH1 may provide the output of the channel amplifier 10 of the first driver 210 to the first and second data lines DL1 and DL2 in response to the first and second selection signals CLA and CLB, respectively. The first and second switches SW11 and SW12 may operate as a multiplexer for connecting the first channel CH1 to the first or second data line DL1 or DL2.

The third switch SW21 is turned on in response to the first select signal CLA and the fourth switch SW22 is turned on in response to the second select signal CLB. The third and fourth switches SW21 and SW22 connected to the second channel CH2 may provide the output of the channel amplifier 10 of the second driver 220 to the third and fourth data lines DL3 and DL4 in response to the first and second selection signals CLA and CLB, respectively. The third and fourth switches SW21 and SW22 may operate as a multiplexer for connecting the second channel CH2 to the third or fourth data line DL3 or DL4.

The first to fourth switches SW11, SW12, SW21, and SW22 may be turned on at different times during a horizontal time period in response to the first selection signal CLA or the second selection signal CLB. The first and second selection signals CLA and CLB may be alternately generated for horizontal time periods H1, H2, H3, and H4, as shown in FIG. 3.

Image signals may be provided to the first to fourth pixels PX11, PX12, PX13, and PX14 of the first horizontal line on a time-sharing basis through the first to fourth switches SW11, SW12, SW21, and SW22, respectively. For example, for the first horizontal time period H1, the pixels PX11 and PX13 may be simultaneously driven and the pixels PX12 and PX14 may be simultaneously driven. For the second horizontal time period H2, the pixels PX21 and PX23 may be simultaneously driven and the pixels PX22 and PX24 may be simultaneously driven.

The pixels PX11, PX13, PX21, and PX23, connected to the first and third switches SW11 and SW21 responding to the first selection signal CLA among the pixels PX11 to PX24 of the display panel 110, will be referred to as a first pixel group. The pixels PX11, PX13, PX21 and PX23 of the first pixel group are connected to the odd data lines DL1 and DL3 of the display panel 110.

The pixels PX12, PX14, PX22, and PX24, connected to the second and fourth switches SW12 and SW22 responding to the second selection signal CLB among the pixels PX11 to PX24 of the display panel 110, will be referred to as a second pixel group. The pixels PX12, PX14, PX22 and PX24 of the second pixel group are connected to the even data lines DL2 and DL4 of the display panel 110.

In the display panel 110, pixels included in the same pixel group may be simultaneously driven for one horizontal time period. For the first horizontal time period H1, the pixels PX11 and PX13 of the first pixel group connected to the odd data lines DL1 and DL3 may be simultaneously driven and the pixels PX12 and PX14 of the second pixel group connected to the even data lines DL2 and DL4 may be simultaneously driven. For the second horizontal time period H2, the pixels PX21 and PX23 of the first pixel group connected to the odd data lines DL1 and DL3 may be simultaneously driven and the pixels PX22 and PX24 of the second pixel group connected to the even data lines DL2 and DL4 may be simultaneously driven.

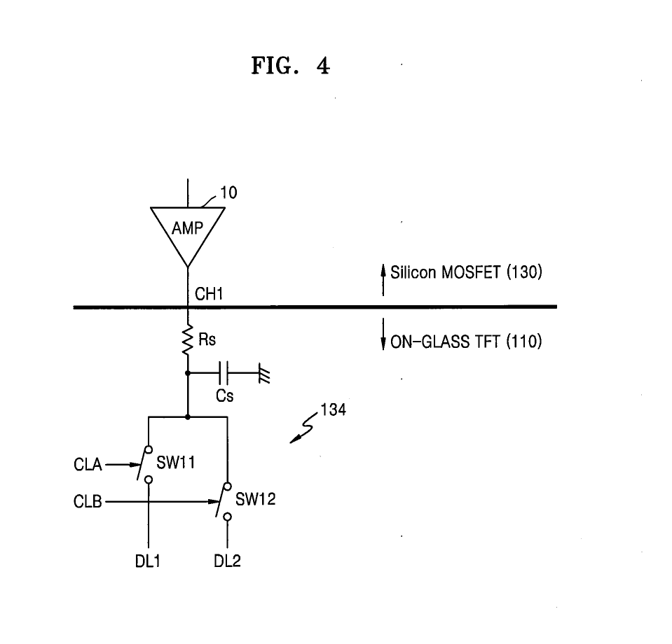

In the current embodiment, the channel amplifier 10 in each of the drivers 210 and 220 may alternately drive two data lines, that is, the odd data line DL1 or DL3 and the even data line DL2 or DL4. This case may reduce the number of channel amplifiers 10 compared to a case where channel amplifiers are arranged corresponding to the data lines DL1, DL2, DL3 and DL4 to drive the data lines DL1, DL2, DL3 and DL4, respectively. Accordingly, the chip area of the DDI 130 may be reduced. Furthermore, the switches SW11, SW12, SW21, and SW22 of the switching circuit 134 may be integrated into the DDI 130, so that the power consumption of the DDI 130 may be reduced. This integration of the switches into the DDI 130 will be described with reference to a comparative example of FIG. 4.

FIG. 4 is a diagram illustrating an example in which a switching circuit 134 is disposed in or integrated as a part of a display panel 110, as a comparative example of FIG. 2.

Referring to FIG. 4, first and second switches SW11 and SW12 of the switching circuit 134 may be implemented as a TFT on the display panel 110, which is a part of a display screen, as compared with FIG. 2. The output of a channel amplifier 10 may be provided to a first channel CH1, and the first channel CH1 may be connected to the first and second switches SW11 and SW12 of the switching circuit 134. A load resistor Rs and a load capacitor Cs may be between the first channel CH1 and the first and second switches SW11 and SW12 according to wiring on the display panel 110.

A first selection signal CLA and a second selection signal CLB for driving the first switch SW11 and the second switch SW12, respectively may be provided from a DDI 130. Each of the first and second selection signals CLA and CLB may be provided as a pulse signal with one horizontal time as a period, as shown in FIG. 3. When the first and second selection signals CLA and CLB are provided from the DDI 130, an operation current I as expressed by Equation 1 may be generated due to a load capacitor Cs.

I=Cs·V·f [Equation 1]

Here, V denotes an output voltage of the channel amplifier 10 and f denotes the horizontal time period.

The driving current of the channel amplifier 10 may increase due to the operation current I generated due to the load capacitor Cs and thus the power consumption of the DDI 130 may increase. In order to reduce the power consumption of the DDI 130, the switches SW11 and SW12 of the switching circuit 134 are disposed in the DDI 130, as described with reference to FIG. 2.

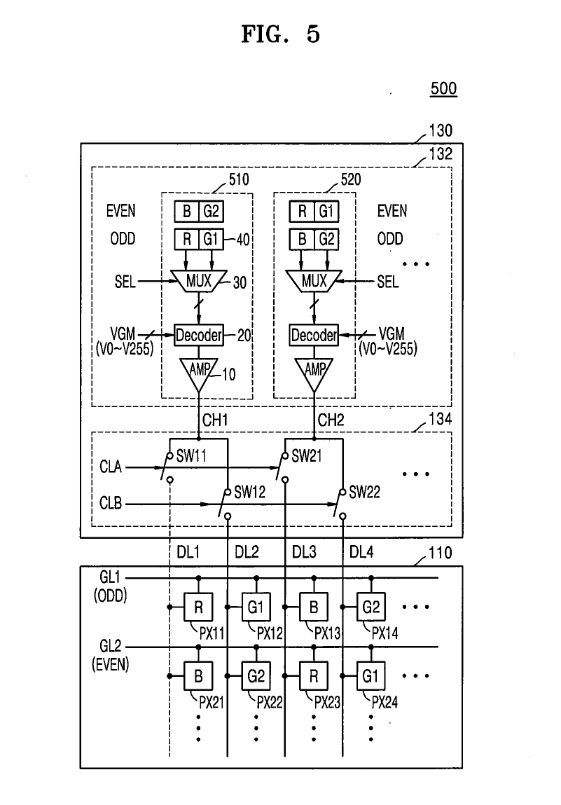

FIG. 5 is a diagram illustrating a display device 500 according to other embodiments of the inventive concept. The display device 500 of FIG. 5 has a pentile structure in which pixels PX of a display panel 110 are repeatedly arranged in the order of R, G, B, and G, or in the order of B, G, R, and G. In the display panel 110 having the pentile structure, pixels PX connected to odd gate lines may be arranged in the order of R, G, B, and G, and pixels PX connected to even gate lines may be arranged in the order of B, G, R, and G.

Referring to FIG. 5, a DDI 130 and the display panel 110 of the display device 500 may be different from the DDI 130 and the display panel 110 of the display device 100 shown in FIG. 2, and the remaining components of the display device 500 may be the same as the remaining components of the display device 100. Hereinafter, differences from FIG. 2 will be mainly described.

The DDI 130 may be implemented as a single semiconductor IC chip including a driver circuit 132 and a switching circuit 134. The driver circuit 132 includes a plurality of drivers, that is, first and second drivers 510 and 520, and the switching circuit 134 includes a plurality of switches SW11, SW12, SW21, and SW22.

Each of the first and second drivers 510 and 520 may include a channel amplifier 10, a decoder 20, a multiplexer 30, and a latch 40. A plurality of pieces of pixel data corresponding to pixels driven by the first and second drivers 510 and 520 may be stored in the latch 40 on a line-by-line basis. The first driver 510 may drive pixels PX11, PX12, PX21, and PX22 connected to first and second data lines DL1 and DL2, and the second driver 520 may drive pixels PX13, PX14, PX23, and PX24 connected to third and fourth data lines DL3 and DL4.

Red (R) data and green (G1) data may be stored in the latch 40 of the first driver 510 when an odd gate line (e.g., a first gate line GL1) of the display panel 110 is driven. The R data and the G1 data may be applied to the multiplexer 30 and may be selected according to a data selection signal SEL and output to the decoder 20. Blue (B) data and green (G2) data may be stored in the latch 40 of the second driver 520. The B data and the G2 data may be applied to the multiplexer 30 and may be selected according to the data selection signal SEL and output to the decoder 20. The data selection signal SEL may be activated in synchronization with one of the first and second selection signals CLA and CLB.

The decoder 20 of the first driver 510 may select and output a gamma voltage corresponding to the R data or G1 data selected by the data selection signal SEL from among a plurality of gamma voltages VGM. The decoder 20 of the first driver 510 may select the gamma voltage corresponding to the R data or G1 data and output the selected gamma voltage to the channel amplifier 10 of the first driver 510. The channel amplifier 10 of the first driver 510 may output a gamma voltage, received from the decoder 20 of the first driver 510, as an image signal. The channel amplifier 10 of the first driver 510 may output the image signal through a first channel CH1.

The decoder 20 of the second driver 520 may select and output a gamma voltage corresponding to the B data or G2 data selected by the data selection signal SEL from among a plurality of gamma voltages VGM. The decoder 20 of the second driver 520 may select the gamma voltage corresponding to the B data or the G2 data and output the selected gamma voltage to the channel amplifier 10 of the second driver 520. The channel amplifier 10 of the second driver 520 may output the gamma voltage, received from the decoder 20 of the second driver 520, as an image signal. The channel amplifier 10 of the second driver 520 may output the image signal through a second channel CH2.

When an odd gate line of the display panel 110 is driven, the first switch SW11 and the third switch SW21 of the switching circuit 134 are turned on in response to the first selection signal CLA. The multiplexer 30 of the first driver 510 may output the R data to the decoder 20 of the first driver 510 in response to the data selection signal SEL, and the channel amplifier 10 of the first driver 510 may output a gamma voltage corresponding to the R data. The multiplexer 30 of the second driver 520 may output the B data to the decoder 20 of the second driver 520 in response to the data selection signal SEL, and the channel amplifier 10 of the second driver 520 may output a gamma voltage corresponding to the B data. R data and B data, output from the channel amplifiers 10 of the first and second drivers 510 and 520, respectively, may be provided as image signals to the pixels PX11 and PX13, respectively.

Thereafter, the second switch SW12 and the fourth switch SW22 of the switching circuit 134 are turned on in response to the second selection signal CLB. The multiplexer 30 of the first driver 510 may output the G1 data to the decoder 20 of the first driver 510 in response to the data selection signal SEL, and the channel amplifier 10 of the first driver 510 may output a gamma voltage corresponding to the G1 data. The multiplexer 30 of the second driver 520 may output the G2 data to the decoder 20 of the second driver 520 in response to the data selection signal SEL, and the channel amplifier 10 of the second driver 520 may output a gamma voltage corresponding to the G2 data. G1 data and G2 data, output from the channel amplifiers 10 of the first and second drivers 510 and 520, respectively, may be provided as image signals to the pixels PX12 and PX14, respectively.

B data and G2 data may be stored in the latch 40 of the first driver 510 when an even gate line (e.g., a second gate line GL2) of the display panel 110 is driven. The B data and the G2 data may be applied to the multiplexer 30 of the first driver 510, and may be selected according to the data selection signal SEL and output to the decoder 20 of the first driver 510.

The decoder 20 of the first driver 510 may select and output a gamma voltage corresponding to the B data or G2 data selected by the data selection signal SEL from among the plurality of gamma voltages VGM. The decoder 20 of the first driver 510 may select a gamma voltage corresponding to the B data or G2 data and output the selected gamma voltage to the channel amplifier 10 of the first driver 510. The channel amplifier 10 of the first driver 510 may output a gamma voltage, received from the decoder 20 of the first driver 510, as an image signal to the first channel CH1.

R data and G1 data may be stored in the latch 40 of the second driver 520. The R data and the G1 data may be applied to the multiplexer 30 of the second driver 520, and may be selected according to the data selection signal SEL and output to the decoder 20 of the first driver 510.

The decoder 20 of the second driver 520 may select and output a gamma voltage corresponding to the R data or G1 data selected by the data selection signal SEL from among the plurality of gamma voltages VGM. The decoder 20 of the second driver 520 may select a gamma voltage corresponding to the R data or G1 data and output the selected gamma voltage to the channel amplifier 10 of the second driver 520. The channel amplifier 10 of the second driver 520 may output the gamma voltage, received from the decoder 20 of the second driver 520, as an image signal to the second channel CH2.

When an even gate line of the display panel 110 is driven, the first switch SW11 and the third switch SW21 of the switching circuit 134 are turned on in response to the first selection signal CLA. The multiplexer 30 of the first driver 510 may output the B data to the decoder 20 of the first driver 510 in response to the data selection signal SEL, and the channel amplifier 10 of the first driver 510 may output a gamma voltage corresponding to the B data. In addition, the multiplexer 30 of the second driver 520 may output the R data to the decoder 20 of the second driver 520 in response to the data selection signal SEL, and the channel amplifier 10 of the second driver 520 may output a gamma voltage corresponding to the R data. B data and R data, output from the channel amplifiers 10 of the first and second drivers 510 and 520, respectively, may be provided as image signals to the pixels PX21 and PX23, respectively.

Thereafter, the second switch SW12 and the fourth switch SW22 of the switching circuit 134 are turned on in response to the second selection signal CLB. The multiplexer 30 of the first driver 510 may output the G2 data to the decoder 20 of the first driver 510 in response to the data selection signal SEL, and the channel amplifier 10 of the first driver 510 may output a gamma voltage corresponding to the G2 data. In addition, the multiplexer 30 of the second driver 520 may output the G1 data to the decoder 20 of the second driver 520 in response to the data selection signal SEL, and the channel amplifier 10 of the second driver 520 may output a gamma voltage corresponding to the G1 data. G2 data and G1 data, output from the channel amplifiers 10 of the first and second drivers 510 and 520, respectively, may be provided as image signals to the pixels PX22 and PX24, respectively.

In the current embodiment, the switches SW11, SW12, SW21, and SW22 of the switching circuit 134 are disposed in the DDI 130 that drives the display panel 110 having a pentile structure. Accordingly, the display device 500 does not have the load resistance Rs and the load capacitance Cs shown in FIG. 4. Since the DDI 130 does not generate an operation current due to the load capacitor Cs, the power consumption of the DDI 130 may be reduced.

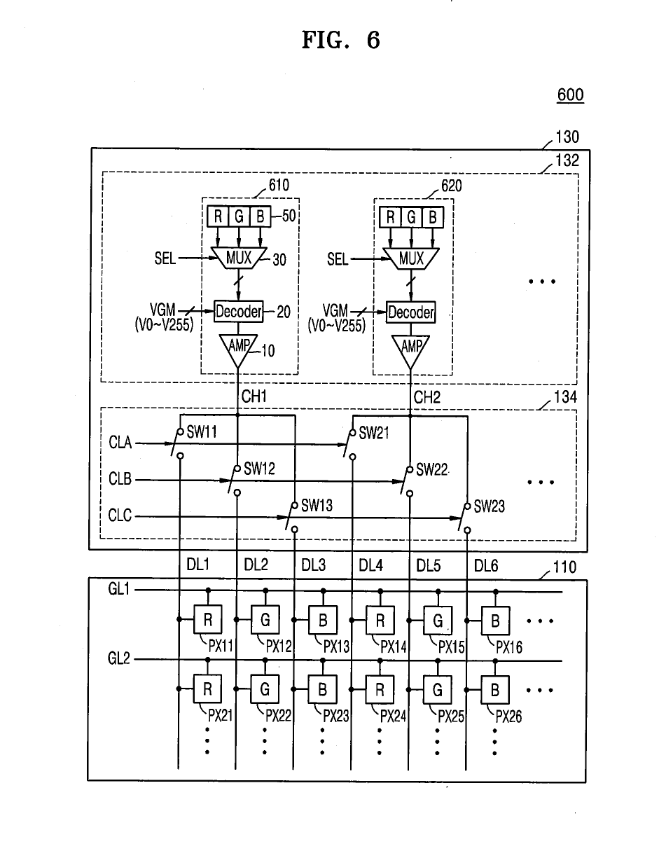

FIG. 6 is a diagram illustrating a display device 600 according to another embodiment of the inventive concept. The display device 600 of FIG. 6 has an RGB stripe structure in which pixels PX of a display panel 110 are repeatedly arranged in the order of R, G, and B. According to an embodiment, the pixels PX of the display panel 110 may be repeatedly arranged in the order of B, G, and R.

Referring to FIG. 6, a DDI 130 and the display panel 110 of the display device 600 are different from the DDI 130 and the display panel 110 of the display device 100 shown in FIG. 2, and the remaining components of the display device 600 are the same as the remaining components of the display device 100. Hereinafter, the difference from FIG. 2 will be mainly described.

The DDI 130 may be implemented as a single semiconductor IC chip including a driver circuit 132 and a switching circuit 134. The driver circuit 132 includes a plurality of drivers, that is, first and second drivers 610 and 620, and the switching circuit 134 includes a plurality of switches SW11, SW12, SW13, SW21, SW22, and SW23.

Each of the first and second drivers 610 and 620 may include a channel amplifier 10, a decoder 20, a multiplexer 30, and a latch 50. A plurality of pieces of pixel data corresponding to pixels driven by the first and second drivers 610 and 620 may be stored in the latch 50 on a line-by-line basis. The first driver 610 may drive pixels PX11, PX12, PX13, PX21, PX22, and PX23 connected to first to third data lines DL1 to DL3. The second driver 620 may drive pixels PX14, PX15, PX16, PX24, PX25, and PX26 connected to fourth to sixth data lines DL4 to DL6.

Red (R) data, green (G) data, and blue (B) data may be stored in the latch 50 of each of the first and second drivers 610 and 620 when a gate line (e.g., a first gate line GL1) of the display panel 110 is driven. The R data, the G data, and the B data may be applied to the multiplexer 30 and may be selected according to a data selection signal SEL and output to the decoder 20. The data selection signal SEL may be activated in synchronization with one of first to third selection signals CLA, CLB, and CLC. Each of the first to third selection signals CLA, CLB, and CLC may be provided as a pulse signal with one horizontal time as a period.

The decoder 20 of the first driver 610 may select and output a gamma voltage corresponding to the R data, G data, or B data selected by the data selection signal SEL from among a plurality of gamma voltages VGM. The decoder 20 of the first driver 610 may select a gamma voltage corresponding to the R data, in response to a data selection signal SEL synchronized with the first selection signal CLA, and output the selected gamma voltage to the channel amplifier 10 of the first driver 610. The decoder 20 of the first driver 610 may select a gamma voltage corresponding to the G data, in response to a data selection signal SEL synchronized with the second selection signal CLB, and output the selected gamma voltage to the channel amplifier 10 of the first driver 610. The decoder 20 of the first driver 610 may select a gamma voltage corresponding to the B data, in response to a data selection signal SEL synchronized with the third selection signal CLC, and output the selected gamma voltage to the channel amplifier 10 of the first driver 610.

The channel amplifier 10 of the first driver 610 may output a gamma voltage, received from the decoder 20 of the first driver 610, as an image signal. The channel amplifier 10 of the first driver 610 may output the image signal through a first channel CH1. The first channel CH1 may be selectively connected to the first to third data lines DL1, DL2, and DL3 through the first to third switches SW11, SW12, and SW13 of the switching circuit 134.

The decoder 20 of the second driver 620 may select a gamma voltage corresponding to the R data, G data, or B data selected by the data selection signal SEL from among a plurality of gamma voltages VGM and output the selected gamma voltage to the channel amplifier 10 of the second driver 620. The channel amplifier 10 of the second driver 620 may output a gamma voltage, received from the decoder 20 of the second driver 620, as an image signal through a second channel CH2. The second channel CH2 may be selectively connected to the fourth to sixth data lines DL4, DL5, and DL6 through the fourth to sixth switches SW21, SW22, and SW23 of the switching circuit 134.

The first to third switches SW11, SW12 and SW13 of the switching circuit 134 may be connected between the first channel CH1 and the first to third data lines DL1, DL2, and DL3, respectively. The fourth to sixth switches SW21, SW22, and SW23 may be connected between the second channel CH2 and the fourth to sixth data lines DL4, DL5, and DL6, respectively.

Each of the first to third switches SW11, SW12 and SW13 connected to the first channel CH1 may connect the first channel CH1 to one of the first to third data lines DL1, DL2, and DL3 in response to one of the first to third selection signals CLA, CLB and CLC. The first switch SW11 connects the first channel CH1 to the first data line DL1 in response to the first selection signal CLA, the second switch SW2 connects the first channel CH1 to the second data line DL2 in response to the second selection signal CLB, and the third switch SW13 connects the first channel CH1 to the third data line DL3 in response to the third selection signal CLC. The first to third switches SW11, SW12 and SW13 may operate as a multiplexer for connecting the first channel CH1 to the first to third data lines DL1, DL2, and DL3.

Each of the fourth to sixth switches SW21, SW22 and SW23 connected to the second channel CH2 may connect the second channel CH2 to one of the fourth to sixth data lines DL4, DL5, and DL6 in response to one of the first to third selection signals CLA, CLB, and CLC. The fourth switch SW21 connects the second channel CH2 to the fourth data line DL4 in response to the first selection signal CLA, the fifth switch SW22 connects the second channel CH2 to the fifth data line DL5 in response to the second selection signal CLB, and the sixth switch SW23 connects the second channel CH2 to the sixth data line DL6 in response to the third selection signal CLC. The fourth to sixth switches SW21, SW22 and SW23 may operate as a multiplexer for connecting the second channel CH2 to the fourth to sixth data lines DL4, DL5 and DL6.

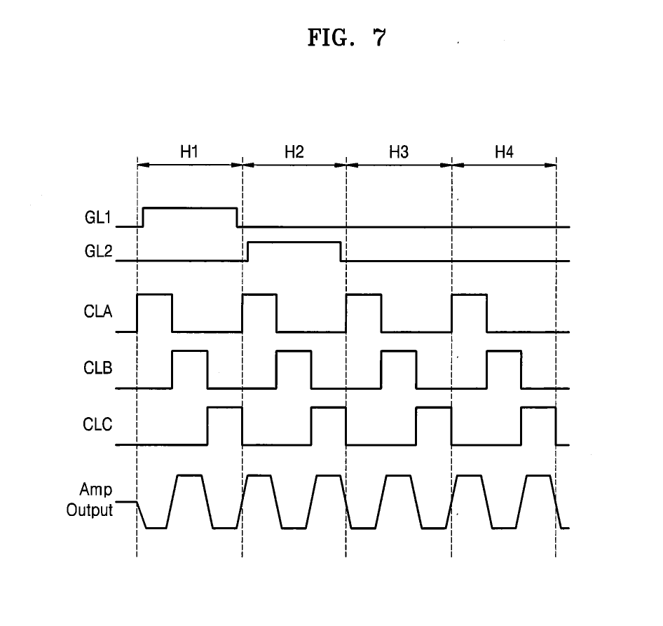

The first to sixth switches SW11, SW12, SW13, SW21, SW22, and SW23 may be turned on at different times during a horizontal time period in response to the first, second, or third selection signal CLA, CLB or CLB. The first to third selection signals CLA, CLB, and CLC may be generated in a mutually exclusive manner for horizontal time periods H1, H2, H3, and H4, as shown in FIG. 7. Accordingly, image signals may be provided to the first and fourth pixels PX11 and PX14, the second and fifth pixels PX12 and PX15, and the third and sixth pixels PX13 and PX16 of a first horizontal line on a time-sharing basis.

During a first horizontal time period H1, the pixels PX11 and PX14 may be simultaneously driven to an image signal corresponding to the R data by the first selection signal CLA, the pixels PX12 and PX15 may be simultaneously driven to an image signal corresponding to the G data by the second selection signal CLB, and the pixels PX13 and PX16 may be simultaneously driven to an image signal corresponding to the B data by the third selection signal CLC.

During a second horizontal time period H2, the pixels PX21 and PX24 may be simultaneously driven to an image signal corresponding to the R data by the first selection signal CLA, the pixels PX22 and PX25 may be simultaneously driven to an image signal corresponding to the G data by the second selection signal CLB, and the pixels PX23 and PX26 may be simultaneously driven to an image signal corresponding to the B data by the third selection signal CLC.

In some embodiments, the channel amplifier 10 in the first driver 610 may alternately drive three data lines DL1 to DL3 and the channel amplifier 10 in the second driver 620 may alternately drive three data lines DL4 to DL6. Accordingly, the number of channel amplifiers 10 may be reduced, and thus the chip area of the DDI 130 may be reduced. In addition, the switches SW11, SW12, SW13, SW21, SW22, and SW23 of the switching circuit 134 may be disposed in the DDI 130, thereby reducing the power consumption of the DDI 130.

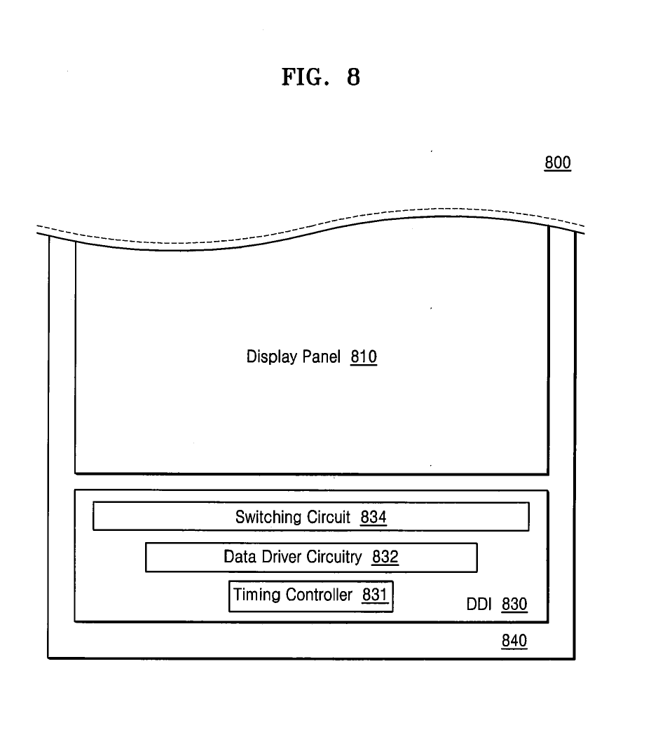

FIG. 8 is a view illustrating a display module 800 including a display device according to embodiments of the inventive concept.

Referring to FIG. 8, the display module 800 may include a display panel 810 and a DDI 830. The DDI 830 may be implemented as a single semiconductor IC chip including a timing controller 831, a data driver circuit 832 and a switching circuit 834.

The DDI 830 may be mounted, in a chip on glass (COG) form, on a lower substrate 840 having the display panel 810. Signals output from the DDI 830 may be provided to the display panel 810 through a wiring line patterned on the substrate 840. The switching circuit 834 included in the DDI 830 corresponds to the switching circuit 134 described with reference to FIGS. 1 to 7. The switching circuit 834 may connect a plurality of channels, which output image signals to be displayed on pixel groups connected to one gate line of the display panel 810, to data lines of the display panel 810. The switching circuit 834 may selectively connect each of the plurality of channels to data lines of a corresponding pixel group according to a selection signal indicating a display order of the pixel groups and provide the image signals to the selected data lines.

The display module 800 may be mounted on a small or medium-sized electronic device such as a smart phone, a tablet PC, or a smart watch.

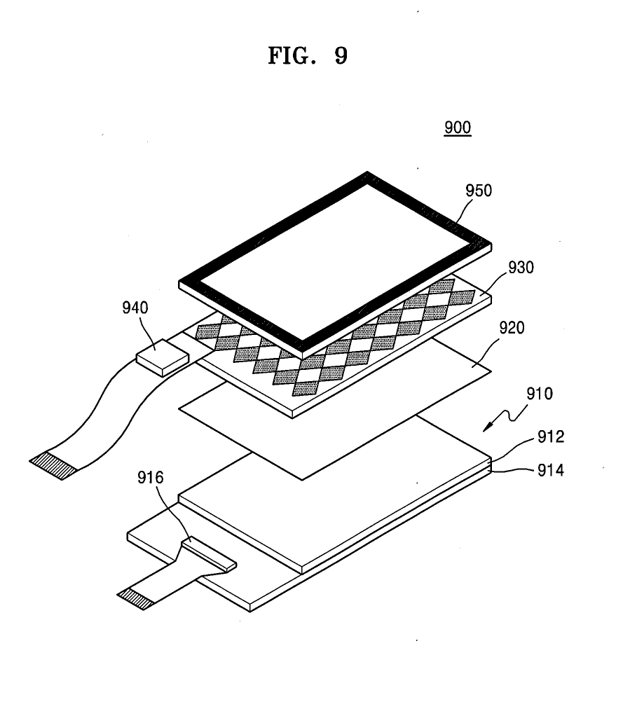

FIG. 9 is a view illustrating a touch screen module 900 to which a display device according to embodiments of the inventive concept is applied.

Referring to FIG. 9, the touch screen module 900 may include a display device 910, a polarizing plate 920, a touch panel 930, a touch controller 940, and a window glass 950. The display device 910 may include a display panel 912, a substrate 914, and a DDI 916. The display device 910 may correspond to the display devices 100, 500, and 600 described with reference to FIGS. 1 to 7.

The window glass 950 may include acrylic or tempered glass to protect the touch screen module 900 from external impact or scratches due to repetitive touches. The polarizing plate 920 may improve optical characteristics of the display panel 912. The display panel 912 may be formed by patterning a transparent electrode on the substrate 914. The display panel 912 may include a plurality of pixels for displaying image frames.

The display panel 912 may be a liquid crystal panel. However, the inventive concept is not limited thereto, and the display panel 912 may include various types of display elements. For example, the display panel 912 may include an organic light-emitting diode (OLED), an electrochromic display (ECD), a digital mirror device (DMD), an actuated mirror device (AMD), a grating light value (GLV), a plasma display panel (PDP), an electro luminescent display (ELD), a light-emitting diode (LED) display, or a vacuum fluorescent display (VFD).

The DDI 916 may be implemented as a single semiconductor IC chip including a driver circuit for driving data lines of the display panel 912 and a switching circuit. The switching circuit may connect a plurality of channels, which output image signals to be displayed on pixel groups connected to one gate line of the display panel 912, to data lines of the display panel 912. The switching circuit may selectively connect each of the plurality of channels to data lines of a corresponding pixel group according to a selection signal indicating a display order of the pixel groups and provide the image signals to the selected data lines. According to an embodiment, the DDI 916 may include a gate driver for driving gate lines of the display panel 912.

The DDI 916 may be mounted on the substrate 914, which includes a glass material, in the form of a COG. According to an embodiment, the DDI 916 may be implemented in various forms such as chip on film (COF) and chip on board (COB).

The touch screen module 900 may further include a touch panel 930 and a touch controller 940. The touch panel 930 may be formed by patterning a transparent electrode including a material such as indium tin oxide (ITO) on a glass substrate or a polyethylene terephthalate (PET) film. According to some embodiments, the touch panel 930 may be formed on the display panel 912. Pixels of the touch panel 930 may be combined with pixels of the display panel 912.

The touch controller 940 senses the occurrence of a touch on the touch panel 930, calculates touch coordinates, and transmits the touch coordinates to a host. According to some embodiments, the touch controller 940 and the DDI 916 may be integrated into one semiconductor chip.

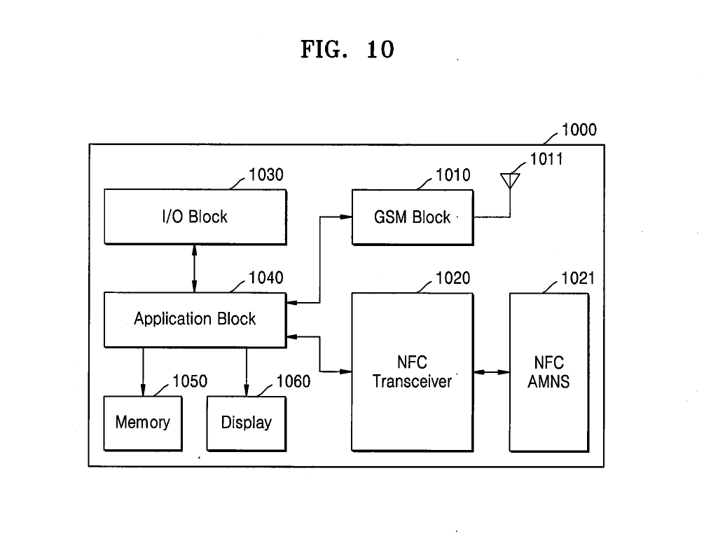

FIG. 10 is a block diagram illustrating an example in which a display device according to embodiments of the inventive concept is applied to a mobile device. The mobile device may be a mobile phone or a smart phone.

Referring to FIG. 10, the mobile device 1000 includes a Global System for Mobile communication (GSM) block 1010, a Near Field Communication (NFC) transceiver 1020, an input/output block 1030, an application block 1040, a memory 1050, and a display device 1060. In FIG. 10, the components/blocks of the mobile device 1000 are illustratively shown. The mobile device 1000 may include more or fewer components/blocks. Also, while the present embodiment is shown using GSM technology, the mobile device 1000 may be implemented using other technologies such as Code Division Multiple Access (CDMA). The blocks of FIG. 10 may be implemented in the form of an integrated circuit. Some of the blocks may be implemented in an integrated circuit form, whereas other blocks may be implemented in a separate form.

The GSM block 1010 is connected to the antenna 1011 and is operable to provide a wireless telephone operation in a known manner. The GSM block 1010 may internally include a receiver and a transmitter to perform reception and transmission operations.

The NFC transceiver 1020 may be configured to transmit and receive NFC signals by using inductive coupling to perform wireless communication. The NFC transceiver 1020 may provide NFC signals to an NFC antenna matching network system 1021, and the NFC antenna matching network system 1021 may transmit the NFC signals through inductive coupling. The NFC antenna matching network system 1021 may receive NFC signals provided from other NFC devices and provide the received NFC signals to the NFC transceiver 1020.

The application block 1040 may include hardware circuits, e.g., one or more processors, and may be operable to provide various user applications provided by the mobile device 1000. The user applications may include voice call operations, data transmission, data swapping, and the like. The application block 1040 may operate in conjunction with the GSM block 1010 and/or the NFC transceiver 1020 to provide operating characteristics of the GSM block 1010 and/or the NFC transceiver 1020. The application block 1040 may include a program for Point Of Sale (POS). Such a program may provide a credit card purchase and payment function using a mobile phone, i.e., a smart phone.

The display device 1060 may display an image in response to display signals received from the application block 1040. The image may be provided by the application block 1040 or may be generated by a camera embedded in the mobile device 1000. The display device 1060 may include a frame buffer for temporary storage of pixel values and may be configured with a liquid crystal display screen together with associated control circuits.

For example, the display device 1060 may correspond to the display device 100, 500, or 600, the display module 800, or the touch screen module 900, described with reference to FIGS. 1 to 9. The display device 1060 may include a display panel including a plurality of pixels, a timing controller that determines a driving order of pixel groups, which are time-divisionally driven for one horizontal time period based on image data to be displayed on the display panel, and generates a selection signal according to the driving order, and a display driver integrated circuit of a single semiconductor chip that converts the image data into image signals according to the selection signal and provides the image signals to data lines of the display panel. The display driver integrated circuit may include a driver circuit for outputting the image signals to a plurality of channels and a switching circuit for selectively connecting each of the plurality of channels to data lines of the corresponding pixel group according to the selection signal.

The input/output block 1030 may provide an input function to a user and provide outputs to be received via the application block 1040.

The memory 1050 may store programs (instructions) and/or data to be used by the application block 1040 and may be implemented with RAM, ROM, a flash memory, and the like. Thus, the memory 1050 may include non-volatile storage elements as well as volatile storage elements.

While the inventive concept has been particularly shown and described with reference to embodiments thereof, it will be understood that various changes in form and details may be made therein without departing from the spirit and scope of the following claims.

What is claimed is:

1. A display driver integrated circuit, the display driver integrated circuit comprising:
a driver circuit configured to output image signals to be displayed on pixel groups connected to one gate line of a display panel to a plurality of channels during one horizontal time period; and
a switching circuit configured to selectively connect each of the plurality of channels to data lines of a corresponding pixel group and provide the image signals to selected data lines, according to a selection signal indicating a display order of the pixel groups,
wherein the display driver integrated circuit is implemented as a single semiconductor chip.

2. The display driver integrated circuit of claim 1, wherein the driver circuit is configured to receive digital image data and convert the digital image data into a gray-scale voltage corresponding to the digital image data and output the gray-scale voltage as the image signals.

3. The display driver integrated circuit of claim 1, wherein the switching circuit comprises switches implemented with metal oxide semiconductor field effect transistors (MOSFETs) connected between each of the plurality of channels and data lines of the display panel.

4. The display driver integrated circuit of claim 3, wherein the switching circuit comprises:
a first switch that provides the image signals to data lines of a first pixel group in response to a first selection signal; and
a second switch that provides the image signals to data lines of a second pixel group in response to a second selection signal.

5. The display driver integrated circuit of claim 3, wherein the switching circuit comprises:
a first switch that provides the image signals to data lines of a first pixel group in response to a first selection signal;
a second switch that provides the image signals to data lines of a second pixel group in response to a second selection signal; and
a third switch that provides the image signals to data lines of a third pixel group in response to a third selection signal.

6. A display device comprising:
a display panel comprising a plurality of pixels;
a timing controller configured to determine a driving order of pixel groups, which are time-divisionally driven for one horizontal time period based on image data to be displayed on the display panel, and configured to generate a selection signal according to the driving order; and
a display driver integrated circuit comprising a single semiconductor chip configured to convert the image data into image signals and configured to provide the image signals to data lines of the display panel, according to the selection signal,
wherein the display driver integrated circuit comprises:
a driver circuit configured to output the image signals to a plurality of channels; and
a switching circuit configured to selectively connect each of the plurality of channels to data lines of a corresponding pixel group according to the selection signal.

7. The display device of claim 6, wherein the driver circuit is configured to convert the image data into a gray-scale voltage corresponding to the image data and output the gray-scale voltage as the image signals.

8. The display device of claim 6, wherein the switching circuit comprises switches implemented with metal oxide semiconductor field effect transistors (MOSFETs) connected between each of the plurality of channels and data lines of the display panel.

9. The display device of claim 8, wherein the selection signal comprises a first selection signal, and wherein the switching circuit comprises:
a first switch that provides the image signals to data lines of a first pixel group in response to the first selection signal; and
a second switch that provides the image signals to data lines of a second pixel group in response to a second selection signal.

10. The display device of claim 9, wherein, when an odd gate line of the display panel is driven, image signals corresponding to red (R) data and blue (B) data are provided to pixels of the first pixel group and image signals corresponding to green (G) data are provided to pixels of the second pixel group.

11. The display device of claim 10, wherein, when an even gate line of the display panel is driven, image signals corresponding to blue (B) data and red (R) data are provided to the pixels of the first pixel group and image signals corresponding to green (G) data are provided to the pixels of the second pixel group.

12. The display device of claim 9, wherein the display panel comprises a panel having a pentile structure.

13. The display device of claim 8, wherein the switching circuit comprises:
a first switch that provides the image signals to data lines of a first pixel group in response to a first selection signal;
a second switch that provides the image signals to data lines of a second pixel group in response to a second selection signal; and
a third switch that provides the image signals to data lines of a third pixel group in response to a third selection signal.

14. The display device of claim 13, wherein the display panel comprises a panel having a red (R), green (G), and blue (B) stripe structure.

15. The display device of claim 6, wherein the timing controller is included in the display driver integrated circuit and the display driver integrated circuit comprises a portion of the single semiconductor chip.

16. A semiconductor chip comprising a display driver integrated circuit, the display driver integrated circuit comprising:
a plurality of driver circuits that are configured to output image signals to a display panel external to the display driver integrated circuit, responsive to respective data selection signals that are based on one or more of a plurality of group selection signals,
wherein activation of ones of the plurality of group selection signals control output of the image signals to respective groups of pixels of a plurality of groups of pixels of the display panel.

17. The semiconductor chip of claim 16,
wherein activation of ones of the plurality of group selection signals are mutually exclusive of activation of others of the plurality of the group selection signals during a horizontal time period.

18. The semiconductor chip of claim 16,
wherein the output of the image signals comprise red (R) data, green (G) data, and/or blue (B) data that drive pixels of one group of the plurality of groups of pixels of the display panel, based on activation of the associated one of the plurality of group selection signals during the horizontal time period.

19. The semiconductor chip of claim 16,
wherein respective ones of the group selection signals control operation of respective groups of switches that are integrated on the semiconductor chip, and
wherein ones of the respective groups of switches control driving of pixels of corresponding ones of the plurality of groups of pixels of the display panel.

20. The semiconductor chip of claim 19,
wherein the plurality of driver circuits are configured to drive a subset of pixels in one of the plurality of groups of pixels, wherein the subset of pixels corresponds to a gate line for which a gate-on signal is applied.
